(19) United States
(12) Patent Application Publication
(10) Pub. No.: US 2018/0156067 A1
(43) Pub. Date: Jun. 7, 2018

(54) Turbocharger Having Thrust Bearing Oil Retainer

(71) Applicant: BorgWarner Inc., Auburn Hills, MI (US)

(72) Inventors: Andrew Taylor, Mirfield (GB); Andrew Day, Huddersfield (GB); Pawel Bakula, Leeds (GB)

(73) Assignee: BorgWarner Inc., Auburn Hills, MI (US)

(21) Appl. No.: 15/368,114

(22) Filed: Dec. 2, 2016

(51) Int. Cl. F01D 25/18; F01D 5/04; F04D 29/28; F04D 29/051

(52) U.S. Cl. CPC F01D 25/186; F01D 5/043; F04D 29/284; F05D 2260/98; F05D 2220/40; F05D 2240/52; F04D 29/051

(57) ABSTRACT

A turbocharger includes a turbine wheel, a compressor wheel, and a shaft coupled to the turbine wheel and the compressor wheel. The turbocharger additionally includes a bearing housing containing a thrust bearing through which the shaft extends. The bearing housing receives oil and drains the oil therefrom. The bearing housing includes a reservoir that maintains a retained portion of the oil received in the bearing housing after the oil is drained from the bearing housing. The retained portion of the oil lubricates the thrust bearing.

### CROSS-REFERENCE TO RELATED APPLICATION(S)

None.

### TECHNICAL FIELD

This disclosure relates to turbochargers and, in particular, thrust bearings thereof and lubrication of thrust bearings.

### BACKGROUND

In the field of internal combustion engines, turbochargers are forced-induction devices that are utilized to increase the pressure of the intake air provided to the engine. Exhaust gases from the engine are routed to the turbocharger and are utilized to drive a turbine wheel. The rotational force generated by the turbine wheel is utilized to drive a compressor wheel, which pressurizes ambient intake air and supplies the pressurized intake air to the engine. By pressurizing the intake air, the amount of air and fuel that can be forced into each cylinder during an intake stroke of the engine is increased. This produces an increased power output relative to a naturally-aspirated engine.

The turbine wheel and the compressor wheel are mounted to a common shaft. The shaft is loaded axially and bears against a thrust washer, which in turn bears axially against the thrust bearing. For example, during operation of the turbocharger, the thrust bearing is axially loaded by the shaft due to force imbalances between the turbine wheel and the compressor wheel (e.g., arising pressure imbalances and wheel geometry). Typically, the axially loading is in a direction from the turbine wheel toward the compressor wheel, but may be directed from the compressor wheel toward the turbine wheel in some applications.

The interface between the thrust bearing and the thrust washer is lubricated by the oil (e.g., engine oil). More specifically, the thrust bearing and the thrust washer are located within a bearing housing through which the shaft extends, and the oil is pumped into the bearing housing while the engine is operating. The oil is removed (e.g., drains) from the bearing housing when the engine is not running. Upon engine startup (e.g., cold start), however, there may be a delay before oil reaches the thrust bearing, for example, due to viscosity of the oil (e.g., having higher viscosity with cooler temperatures), distance from an oil reservoir to the bearing housing, and strength of an oil pump.

### SUMMARY

One aspect of the disclosed embodiments is a turbocharger includes a turbine wheel, a compressor wheel, and a shaft coupled to the turbine wheel and the compressor wheel. The turbocharger additionally includes a bearing housing containing a thrust bearing through which the shaft extends. The bearing housing receives oil and drains the oil therefrom. The bearing housing includes a reservoir that maintains a retained portion of the oil received in the bearing housing after the oil is drained from the bearing housing. The retained portion of the oil lubricates the thrust bearing.

Another aspect of the disclosed embodiments is a subassembly for a turbocharger, which includes a thrust bearing, a thrust washer, and an oil seal plate. The thrust washer is configured to rotate relative to and bear against the thrust bearing with an intervening oil layer. The oil seal plate is configured to seal an opening of a bearing housing of a turbocharger. The oil seal plate includes a receptacle, wherein the thrust bearing and the thrust washer are positioned partially in the receptacle.

In a still further aspect of the disclosed embodiments, a turbocharger includes a turbine wheel, a compressor wheel, and a shaft coupled to the turbine wheel and the compressor wheel. The turbocharger additionally includes a bearing housing, a thrust plate in the bearing housing, and a seal plate that encloses the thrust plate in the bearing housing. The seal plate includes a reservoir that retains a predetermined level of oil in the bearing housing for lubricating the thrust plate.

### BRIEF DESCRIPTION OF THE DRAWINGS

The description herein makes reference to the accompanying drawings, wherein like referenced numerals refer to like parts throughout several views, and wherein:

FIG. 1 is a perspective partial cross-section illustration showing a turbocharger.

FIG. 2 is an upper view of a bearing housing of the turbocharger shown in FIG. 1.

FIG. 3 is a cross-sectional view taken along line 3-3 in FIG. 2.

FIG. 4 is a detail view taken along line 4 in FIG. 3.

FIG. 5 is a perspective view of a seal plate and thrust bearing subassembly of the turbocharger shown in FIG. 1.

FIG. 6 is an exploded perspective view of the seal plate and thrust bearing subassembly shown in FIG. 1.

### DETAILED DESCRIPTION

The disclosure herein is directed to a turbocharger that is configured to maintain a volume of oil within a bearing housing for lubricating a thrust bearing. The volume of oil is maintained in the bearing housing even after engine shutdown, so as to ensure the thrust bearing is lubricated during delays in pumping oil back to the bearing housing during engine startup. Furthermore, by maintaining the volume of oil in the bearing, greater pumping delays may be permitted, thereby allowing for a down-sized oil pump (e.g., with lesser instantaneous pumping capacity) that may require less energy input and residual energy losses (e.g., from a serpentine belt coupled to the engine).

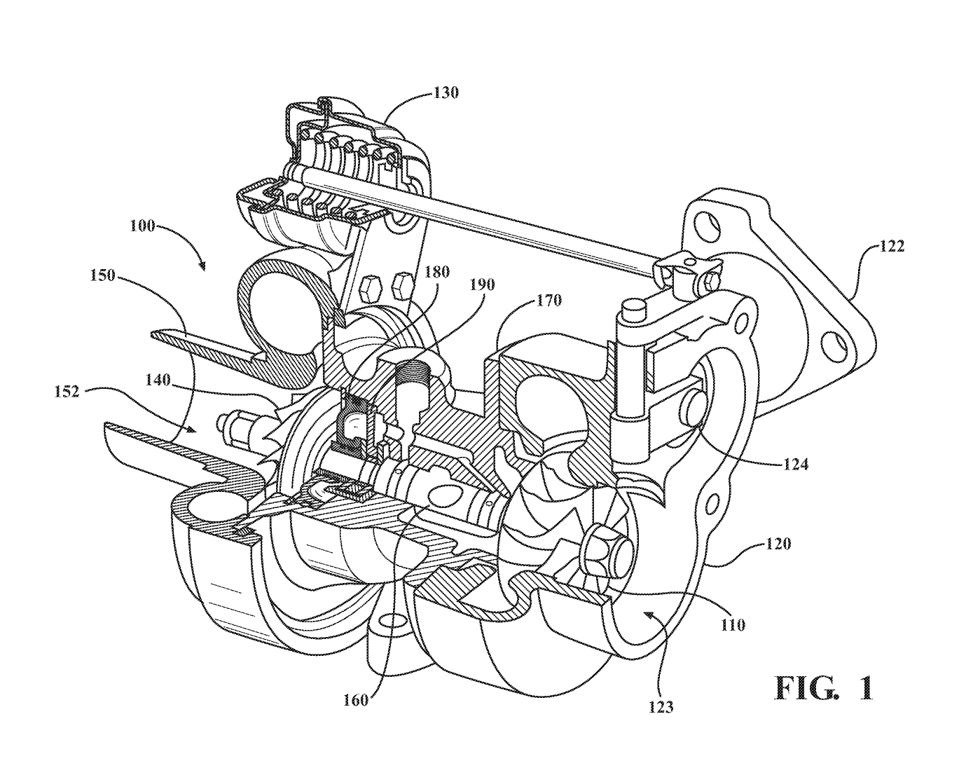

FIG. 1 shows a turbocharger 100. The turbocharger 100 is an exhaust-gas driven forced induction device that is utilized in conjunction with an internal combustion engine (not shown). The turbocharger 100 includes a turbine wheel 110, which will be described further herein. The turbine wheel 110 is located in a turbine housing 120. The turbine housing 120 includes an exhaust gas inlet 122 for receiving exhaust gas from the internal combustion engine. Exhaust gases are routed from the exhaust gas inlet 122 to the turbine wheel 110 before exiting the turbine housing 120 at an exhaust gas outlet 123. A wastegate 124 may be mounted in the turbine housing 120 to allow some or all of the exhaust gas to bypass the turbine wheel 110. The wastegate 124 is movable between an open position and a closed position by a control device 130.

The turbocharger includes a compressor wheel 140. The compressor wheel 140 is located in a compressor housing 150. The compressor housing 150 includes an intake air inlet 152 and an intake air outlet (not shown). Intake air is routed from the intake air inlet 152 to the compressor wheel 140, where the intake air is pressurized by rotation of the compressor wheel 140. The intake air then exits the compressor housing 150 at the intake air outlet before being supplied to the internal combustion engine.

Rotation of the compressor wheel 140 is driven by rotation of the turbine wheel 110. In particular, the turbine wheel 110 and the compressor wheel 140 are each connected to a shaft 160. The shaft 160 can be a substantially rigid member, and each of the turbine wheel 110 and the compressor wheel 140 can be connected to the shaft 160 in a manner that prevents rotation of the turbine wheel 110 and the compressor wheel 140 with respect to the shaft 160. As a result, the compressor wheel 140 can rotate in unison with the turbine wheel 110 in response to rotation of the turbine wheel 110.

The shaft 160 is supported within a bearing housing 170 such that it is able to rotate freely with respect to the bearing housing 170 at a very high rotational speed. The bearing housing 170, the turbine housing 120, and the compressor housing 150 are all arranged along an axis of rotation of the shaft 160. In particular, the bearing housing 170 is positioned between the turbine housing 120 and the compressor housing 150, with a first end of the bearing housing 170 being connected to the turbine housing 120 and a second end of the bearing housing 170 being connected to the compressor housing 150. The bearing housing 170 can incorporate lubrication and/or cooling features.

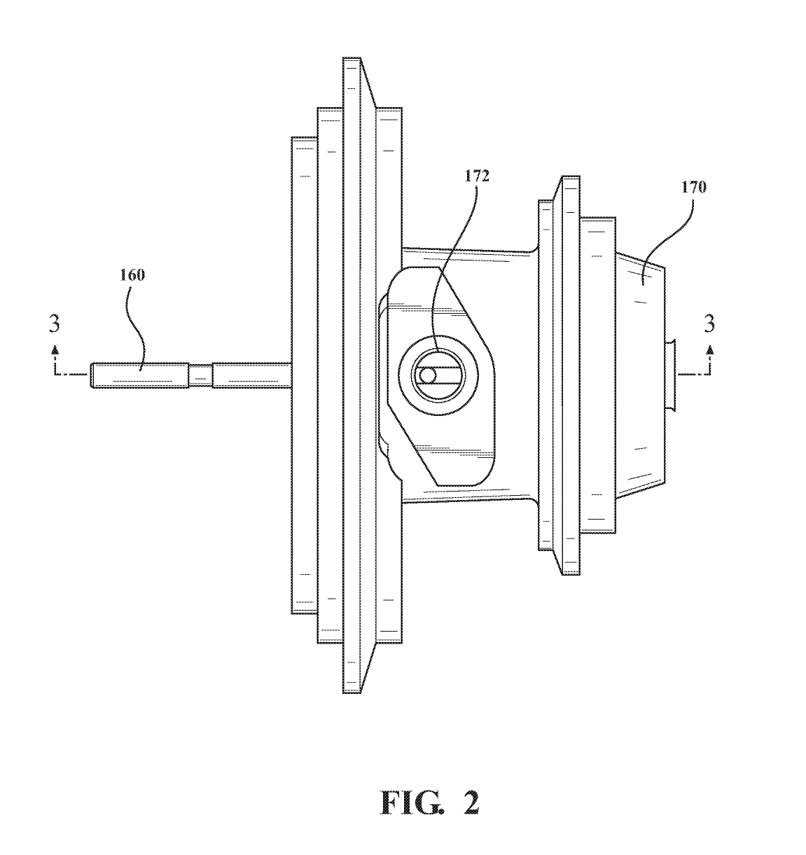

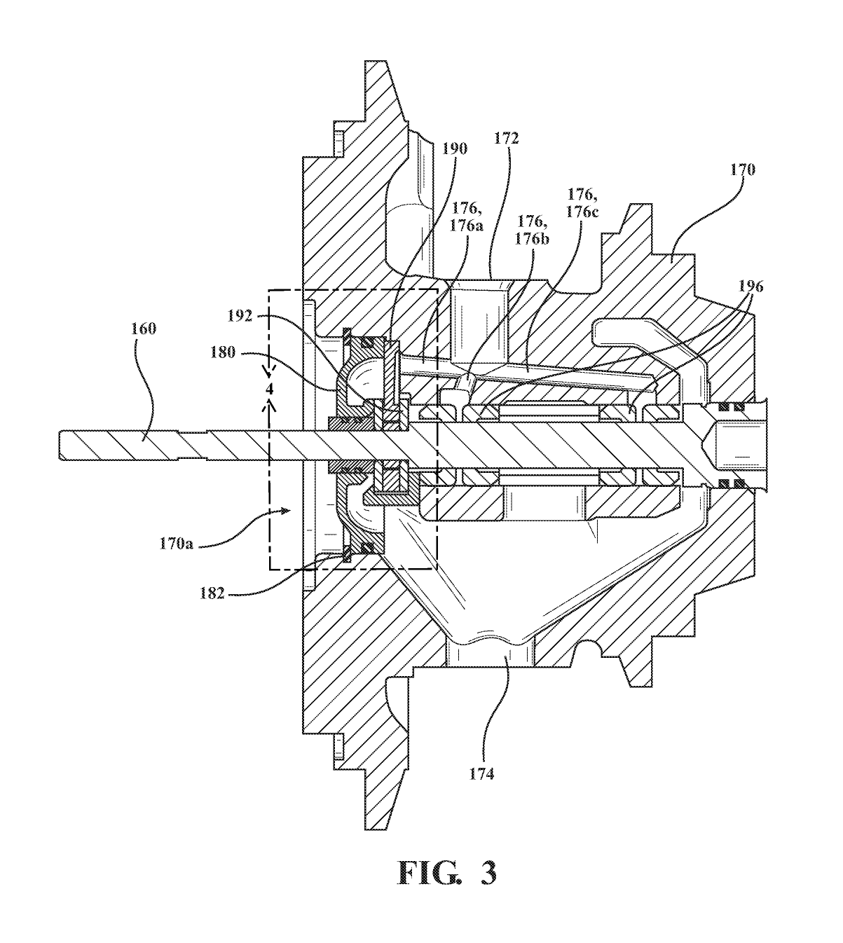

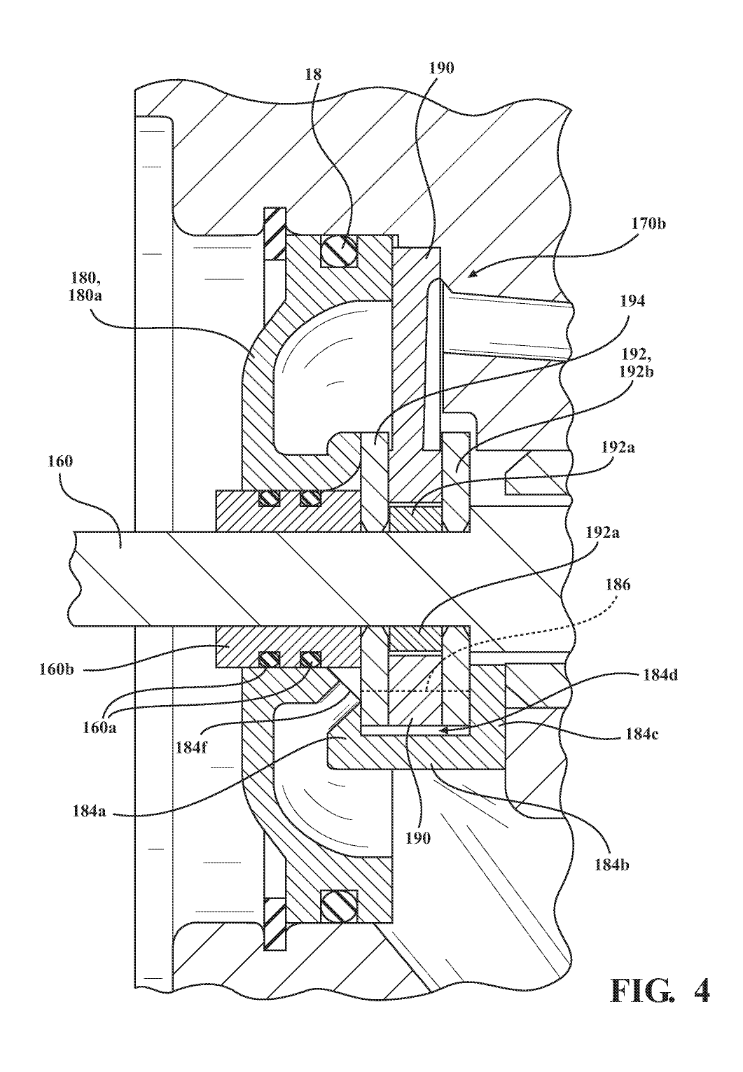

Referring to FIGS. 2-4, the bearing housing 170 defines a cavity, which contains the shaft 160, a thrust bearing 190 (e.g., thrust plate), a thrust washer 192 (e.g., thrust ring, thrust collar, etc.), and one or more journal bearings 196. The cavity is closed by an oil seal plate 180 (e.g., cover, closure, etc.). The shaft 160, the thrust washer 192, the thrust bearing 190, and the oil seal plate 180 function to cooperatively transfer axial force (e.g., axial loading) from the turbine wheel 110 to the bearing housing 170 and, thereby, locate the shaft 160 axially relative to the bearing housing 170. The axial force may be the result of a pressure imbalance between the turbine housing 120 (i.e., at higher pressure) and the compressor housing 150 (i.e., at lower pressure), which applies a net axial force on the shaft 160 in the axial direction moving from the turbine wheel 110 to the compressor wheel 140. The journal bearings 196 maintain the shaft 160 in a radial position within the bearing housing 170.

The bearing housing 170 is additionally configured to receive and drain engine oil therefrom. The bearing housing 170 includes an oil inlet 172 that receives engine oil during operation of the engine (e.g., from an oil pump), and an oil outlet 174 from which the engine oil is drained. Oil conduits 176 receive oil from the oil inlet 172 and supply oil to the thrust bearing 190 (e.g., via a first oil conduit 176a) and to the journal bearings 196 (e.g., via a second oil conduit 176b, and a third oil conduit 176c). As referenced above and discussed in further detail below, the turbocharger 100 is additionally configured to maintain a volume of oil in the bearing housing 170 for lubricating the thrust bearing 190, even after the engine is shut down or oil is otherwise no longer supplied.

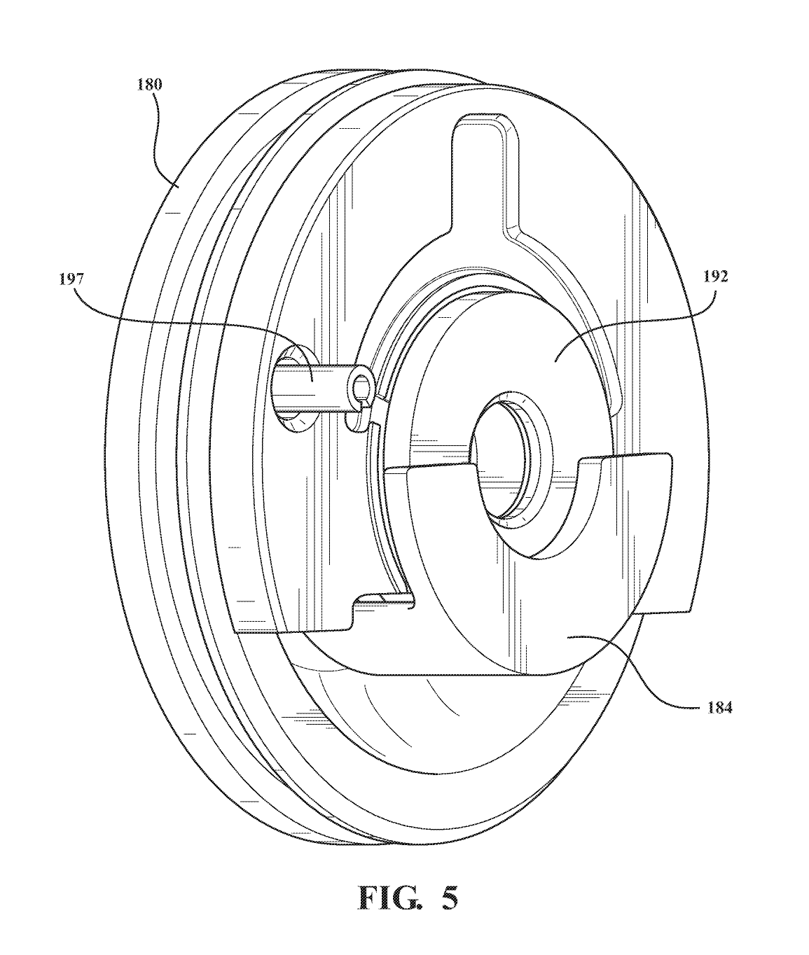

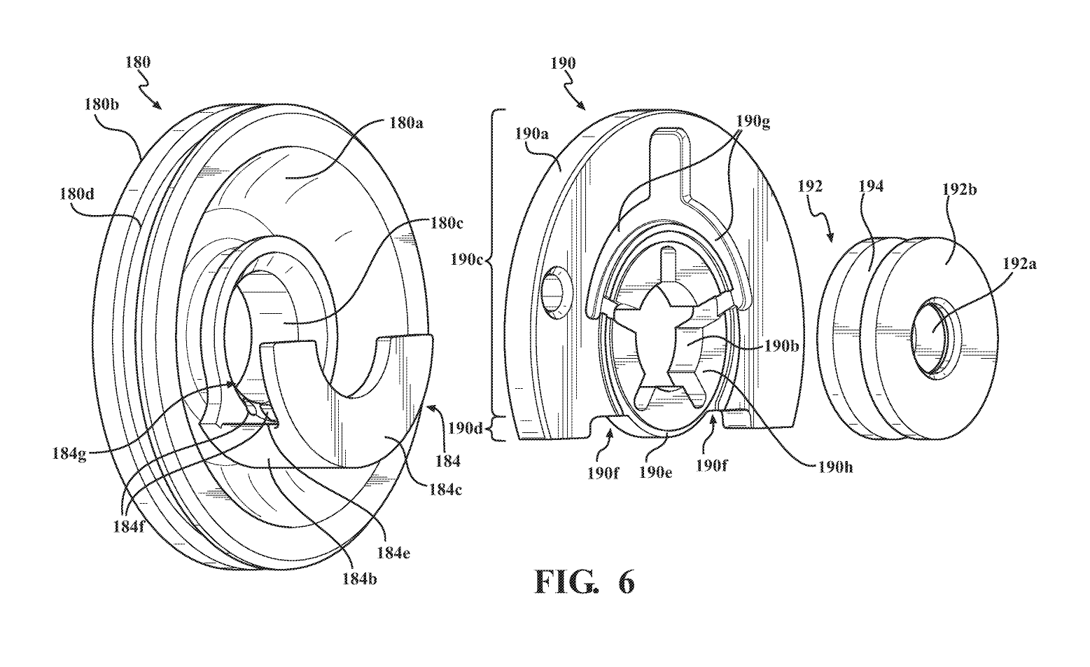

Referring to FIGS. 2-6, the thrust bearing 190 is a plate-like member that the thrust washer 192 bears against axially and rotates relative thereto with an intervening layer of the oil. The thrust bearing 190 is received by the bearing housing 170, for example, in an opening 170a of the bearing housing 170. The thrust bearing 190 is fixed axially with respect to the bearing housing 170, for example, by being arranged and/or compressed between the oil seal plate 180 and a portion of the bearing housing 170 (e.g., a shoulder 170b, step, etc.). The thrust bearing 190 is additionally fixed rotationally relative to the bearing housing 170, for example, with a pin 197 that is received in complementary apertures (not labeled) of the thrust bearing 190 and the bearing housing 170.

The thrust bearing 190 includes an outer periphery 190a and an inner periphery 190b. The outer periphery 190a of the thrust bearing 190 generally forms a truncated circular shape having a circular portion 190c (e.g., upper portion) and a truncated portion 190d (e.g., lower portion, or bottom portion). The circular portion 190c of the outer periphery 190a extends circumferentially approximately 180 degrees or more about a central axis (e.g., between approximately 180 and 270 degrees). The circular portion 190c has a diameter that is smaller than the opening 170a of the bearing housing 170, thereby allowing the thrust bearing 190 to be received by the bearing housing 170. The diameter of the circular portion 190c is larger than the shoulder 170b of the bearing housing 170 adjacent thereto, thereby allowing the thrust bearing 190 to be held axially between the oil seal plate 180 and the shoulder 170b, as referenced above.

The truncated portion 190d of the outer periphery 190a of the thrust bearing 190 extends across the circular portion 190c and faces downward. The truncated portion 190d of the outer periphery 190a of the thrust bearing 190 is configured to be received in a reservoir 184 (e.g., receptacle; discussed in further detail below) of the oil seal plate 180. The truncated portion 190d includes a central region 190e (e.g., lower, lowermost, or bottom portion) that protrudes downward from outer regions 190f (e.g., outer portions) that are adjacent to the central region 190e 190d of the truncated portion 190d of the outer periphery 190a. The central region 190e of the truncated portion 190d has a curved profile or shape that is received within the reservoir 184. The curved profile of the central region 190e may, for example, have a substantially constant radius and be concentric with the inner periphery 190b of the thrust bearing 190 and/or the circular portion 190c of the outer periphery 190a.

The outer regions 190f of the truncated portion 190d of the outer periphery 190a are positioned on each side of the central region 190e and extend radially outward therefrom to the circular portion 190c of the outer periphery 190a. The central region 190e protrudes downward from the outer regions 190f, thereby allowing the central region 190e to be received within the reservoir 184. For example, as shown, the outer regions 190f may form vertical recesses (e.g., concave regions) that receive ends 184e of the reservoir 184 therein.

The inner periphery 190b of the thrust bearing 190 is generally circular. The inner periphery 190b of the thrust bearing 190 is discontinuous (as shown with radial slots), or may be continuous. The inner periphery 190b fully circumscribes the central axis (as shown). In other embodiments, the inner periphery 190b may partially circumscribe the axis (e.g., extending approximately 270 degrees around the central axis).

The thrust bearing 190 may additionally be configured to receive and distribute oil. The thrust bearing 190 receives oil from the first oil conduit 176a. The thrust bearing 190 routes (e.g., distributes) the oil radially inward and axially through channels 190g between the inner axial face of the thrust bearing 190 and the thrust washer 192. The channels 190g are formed in an inner axial face 190h or radially inward portion of of the thrust bearing 190. The thrust bearing may instead include internal channels and/or pads (e.g., inclined bearing surfaces) to which the oil is distributed.

The thrust washer 192 bears against and rotates relative to the inner axial face 190h of the thrust bearing 190. More particularly, the thrust washer 192 includes a cylindrical segment 192a that rotates within the inner periphery 190b of the thrust bearing 190, and a flange segment 192b that slides against the inner axial face 190h of the thrust bearing 190 with a layer of the oil intervening therebetween. The flange segment 192b extends radially outward from one end of the cylindrical segment 192a, for example, to cooperatively form the thrust washer 192 with a T-shaped cross-section. The cylindrical segment 192a includes an outer periphery that engages or is in close proximity to the inner periphery 190b of the thrust bearing 190. The cylindrical segment 192a also includes a central bore (e.g., inner periphery) through which the shaft 160 is received. The cylindrical segment 192a and the flange segment 192b may be provided as separate elements that are held together axially (e.g., being compressed together; as shown), or may integrally formed or otherwise coupled together.

The flange segment 192b of the thrust washer 192 transfers axial loading from the shaft 160 to the thrust bearing 190. The flange segment 192b has a larger diameter than the inner periphery 190b of the thrust bearing 190 to partially or wholly overlap the inner axial face 190h of the thrust bearing 190. The flange segment 192b, thereby, bears against thrust bearing 190 with the oil therebetween lubricating the interface between the thrust bearing 190 and the thrust washer 192. A plate washer 194 may be arranged opposite the flange segment 192b (e.g., axially between oil seal plate 180 and the thrust bearing 190), and is compressed axially against the cylindrical segment 192a, which may function as a spacer between the flange segment 192b and the washer 194. Alternatively, if the inner periphery 190b of the thrust bearing 190 were to only partially circumscribe the central axis (as referenced above), the thrust washer 192 may include the plate washer 194 as a second flange segment extending radially outward from another end of the cylindrical segment 192a opposite the flange segment 192b (e.g., forming an H-shaped cross-section, and being integrally formed or otherwise coupled together).

The oil seal plate 180, as referenced above, functions to transfer axial loading from the turbine wheel 110 to the bearing housing 170. The oil seal plate 180 additionally functions to close or seal the bearing housing 170. The oil seal plate 180 is, for example, received within the opening 170a of the bearing housing 170 and is retained therein, for example, with a snap ring 182 (e.g., internal retaining ring). The oil seal plate 180 includes an outer wall 180a that extends from an outer periphery 180b to an inner periphery 180c. The outer periphery 180b forms a seal with the bearing housing 170. For example, the oil seal plate 180 may include a seal 185 (e.g., gasket, O-ring, etc.) that is received in a circumferential channel 180d in the outer periphery 180b of the oil seal plate 180 to radially engage an inner periphery of the opening 170a of the bearing housing 170.

The inner periphery 180c of the oil seal plate 180 forms an aperture through which the shaft 160 extends. The shaft 160 may be sealed to the inner periphery 180c of the oil seal plate 180 (e.g., with seals 160a and/or an annular member 160b that, for example, form a flinger).

The oil seal plate 180 additionally includes the reservoir 184 referenced above, which may also be described as being a reservoir 184 of the bearing housing 170. The reservoir 184 is configured to retain (e.g., maintain, keep, hold, etc.) a limited amount of oil 186 (e.g., volume, retained volume, retained portion, etc.) within the bearing housing 170 for lubricating the thrust bearing 190. More particularly, the reservoir 184 defines an inner volume 184d (e.g., recess, tank, tub, etc.), which retains the oil 186 in sufficient height and/or volume to contact at least one of the thrust bearing 190 and/or the thrust washer 192 at substantially all times (e.g., even as the engine is shut down, after oil is drained from the bearing housing 170, and/or as oil is otherwise not supplied to the bearing housing 170). The reservoir 184 may be formed integrally with the oil seal plate 180 (e.g., through casting and/or machining processes) or be coupled thereto.

The reservoir 184 protrudes axially inward from the outer wall 180a of the oil seal plate 180 into the bearing housing 170. The reservoir 184 is arranged under the thrust bearing 190 and the thrust washer 192. More particularly, the reservoir 184 extends below the truncated portion 190d of the thrust bearing 190. The reservoir 184 also extends below the thrust washer 192. At least a portion of one or both of the thrust bearing 190 and/or the thrust washer 192 are arranged within the inner volume 184d of the reservoir 184 below a height of the volume of the oil 186 contained therein.

The reservoir 184 includes an outer wall 184a, a lower wall 184b, and an inner wall 184c, which cooperatively define the inner volume 184d. The outer wall 184a extends downward from the inner periphery 180c of the oil seal plate 180. For example, the outer wall 184a may form an upright (e.g., substantially vertical) inner surface of the reservoir 184.

The lower wall 184b of the reservoir 184 protrudes inward (e.g., extends axially) into the cavity of the bearing housing 170. The lower wall 184b extends between lower ends of the outer wall 184a and the inner wall 184c. The lower wall 184b forms a concave inner surface of the reservoir 184. The lower wall 184b extends transversely (e.g., circumferentially or perpendicular to the axial direction) between two ends 184e (e.g., circumferential ends) thereof. The two ends 184e of the lower wall 184b are arranged under (e.g., vertically or directly below) the outer regions 190f of the truncated portion 190d of the thrust bearing 190 (e.g., within the vertical recesses thereof). The two ends 184e of the lower wall 184b are additionally at a vertical position above the central region 190e of the outer periphery 190a of the thrust bearing 190 and/or above a lower end of the thrust washer 192. That is, the central region 190e of the thrust bearing is received between and/or protrudes downward below the ends 184e of the lower wall 184b. As a result, portions of the thrust bearing 190 and/or the thrust washer 192 are positioned within the reservoir 184 and below the level of the oil 186 maintained therein.

The concave inner surface formed by the lower wall 184b may be curved, for example, having a constant radius slightly larger than the thrust washer 192 and/or being concentric with the axis of rotation.

The inner wall 184c extends upward from an inner end of the lower wall 184b. For example, the inner wall 184c may form another substantially vertical inner surface of the reservoir 184 positioned opposite the vertical inner surface of the outer wall 184a. The inner wall 184c has a lower periphery that follows a contour of the concave shape of the lower wall 184b (e.g., having a curved and/or circular shape that is concentric with the shaft 160).

The reservoir also includes drain apertures 184f configured to maintain the oil 186 at a predetermined level (e.g., height or volume) in contact with the thrust bearing 190 and/or thrust washer 192. Any oil 186 above the level of the drain apertures 184f in the inner volume 184d of the reservoir 184 is drained from the inner volume 184d, through the drain apertures 184f, and ultimately to the drain 170d of the bearing housing 170. The drain apertures 184f are arranged at an elevation at or below the ends 184e of the lower wall 184b of the reservoir 184 to, thereby, maintain a level of the oil 186 that is below the height of the ends 184e of the lower wall 184b. The drain apertures 184f may, for example, extend through the outer wall 184a of the reservoir 184 and/or toward the outer wall 180a of the oil seal plate 180 itself.

The inner wall 184c may also extend above the ends 184e of the lower wall 184b. The reservoir 184, thereby, defines a slot 184g between the outer wall 180a of the oil seal plate 180 and the inner wall 184c of the reservoir 184 in which the thrust bearing 190 is received and through which the thrust bearing 190 extends radially. For example, the inner wall 184c extends upward from the ends 184e toward, to (as shown), or beyond an elevation of the axis of the shaft 160. An upper periphery of the inner wall 184c accommodates the shaft 160, for example, by defining a recess (e.g., slot) through which the shaft 160 extends. The recess of the inner wall 184c may have a curved and/or circular shape (e.g., semi-circular) that is concentric with the shaft 160.

The oil seal plate 180, the thrust bearing 190, and the thrust washer 192 may also be considered to form an assembly (e.g., a seal plate and thrust bearing assembly or subassembly), which is inserted as a unit into the opening 170a of the bearing housing 170. The inner wall 184c of the reservoir 184 functions to locate and retain the thrust bearing 190 and the thrust washer 192 during assembly of the turbocharger 100.

It is to be understood that the present disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A turbocharger comprising:
a turbine wheel, a compressor wheel, and a shaft coupled to the turbine wheel and the compressor wheel; and
a bearing housing containing a thrust bearing through which the shaft extends, wherein the bearing housing receives oil and drains the oil therefrom;
wherein the bearing housing includes a reservoir that maintains a retained portion of the oil received in the bearing housing after the oil is drained from the bearing housing, the retained portion of the oil lubricating the thrust bearing.

2. The turbocharger according to claim 1, wherein the thrust bearing is arranged in the reservoir in contact with the retained portion of the oil.

3. The turbocharger according to claim 2, wherein the thrust bearing has a lower portion that protrudes into the reservoir. The turbocharger according to claim 3, wherein the thrust bearing has an outer periphery that includes a truncated portion with a central region, wherein the central region defines the lower portion.

5. The turbocharger according to claim 4, wherein the central region has a constant radius that is concentric with an axis of rotation of the shaft.

6. The turbocharger according to claim 4, wherein the reservoir includes a lower wall having ends at an elevation above the lower portion of the thrust bearing.

7. The turbocharger according to claim 4, wherein the truncated portion of the outer periphery of the thrust bearing includes outer regions between which is the central region, the outer regions being at least partly at an elevation above the lower portion of the thrust bearing.

8. The turbocharger according to claim 1, wherein the reservoir is coupled to an oil seal plate that closes an opening of the bearing housing.

9. The turbocharger according to claim 8, wherein the reservoir is formed integrally with the oil seal plate.

10. The turbocharger according to claim 8, wherein the reservoir protrudes from the oil seal plate into the bearing housing.

11. The turbocharger according to claim 1, wherein the reservoir includes drain apertures configured to limit the retained portion of the oil to a predetermined level.

12. A subassembly for a turbocharger comprising:
a thrust bearing;
a thrust washer configured to rotate relative to and bear against the thrust bearing; and
an oil seal plate configured to seal an opening of a bearing housing of a turbocharger and having a receptacle, wherein the thrust bearing and the thrust washer are positioned partially in the receptacle.

13. The subassembly according to claim 12, wherein the thrust bearing, the thrust washer, and the receptacle are concentrically arranged.

14. The subassembly according to claim 13, wherein the receptacle includes an outer wall, a lower wall, and an inner wall that cooperatively define an oil reservoir in which are received a bottom portion of the thrust bearing and the thrust washer.

15. The subassembly according to claim 12, wherein the thrust bearing has a truncated circular shape having a bottom portion that defines outer regions and a central region that protrudes downward from the outer regions into the receptacle.

16. The subassembly according to claim 15, wherein the outer portions define vertical recess in which are positioned ends of the receptacle.

17. The subassembly according to claim 12, wherein the receptacle includes one or more drain apertures that maintain a predetermined level of oil in the receptacle.

18. The subassembly according to claim 12, wherein oil seal plate includes an outer wall configured to seal with a bearing housing of a turbocharger and an inner wall that at least partly defines the receptacle, and an inner wall that at least partly forms the receptacle and is spaced apart from the outer wall to form a slot therebetween, the thrust bearing extending radially through the slot.

19. The subassembly according to claim 18, wherein the oil seal plate additionally includes a lower wall that at least partly forms the receptacle, wherein the inner wall extends upward above ends of the lower wall.

20. A turbocharger comprising:
a turbine wheel, a compressor wheel, and a shaft coupled to the turbine wheel and the compressor wheel;
a bearing housing, a thrust plate in the bearing housing, and a seal plate that encloses the thrust plate in the bearing housing, wherein the seal plate includes a reservoir that retains a predetermined level of oil in the bearing housing for lubricating the thrust plate.
